(19) United States
(12) Patent Application Publication
(10) Pub. No.: US 2008/0014936 A1
(43) Pub. Date: Jan. 17, 2008

(54) METHODS AND DEVICES FOR COMMUNICATION NETWORK SELECTION BY RECIPIENT

(75) Inventors: ZHENG FANG, ROUND LAKE, IL (US); HOI-HO CHAN, SCHAUMBURG, IL (US)

Correspondence Address: MOTOROLA INC, 600 NORTH US HIGHWAY 45, W4 - 39Q, LIBERTYVILLE, IL, 60048-5343, US

(73) Assignee: MOTOROLA, INC., LIBERTYVILLE, IL (US)

(21) Appl. No.: 11/457,694

(22) Filed: Jul. 14, 2006

(51) Int. Cl. H04Q 7/20

(52) U.S. Cl. 455/435.1

(57) ABSTRACT

Described are methods, and mobile communication devices having multiple communication line capability, for communicating via a first service provider and a second service provider. In one embodiment, a method includes receiving a first communication via the first service provider, the first communication including caller identification information of the first communication. A determination of tariff or signal strength value of the first service provider and the second service provider is made. If tariff or signal strength value of the second service provider is superior over that of the first service provider, the second service provider may be selected. The first communication is terminated and a second communication instigated based on the caller identification information via the second service provider. In another embodiment, the method includes prompting the caller to indicate whether to initiate the second communication. Accordingly, the caller need not know if the called party is within Wi-Fi range.

### FIELD

Disclosed are mobile communication devices and methods of a mobile communication device for communication via multiple service providers, and more particularly for selection of a service provider by a mobile communication device receiving a communication.

### BACKGROUND

Mobile communication devices, such as battery powered cellular telephones, are equipped with multiple transceivers for multi-mode operations. In one mode, the devices can receive signals via radio frequencies pursuant to communication protocols such as CDMA and GSM of cellular networks that have mature infrastructures. In other modes, mobile communication devices can receive communication from a plurality of other sources. For communication over Wireless Fidelity (Wi-Fi®) or a wireless local area network (WLAN), mobile communication devices are coming equipped with a Wi-Fi transceiver. So-called Wi-Fi “hot spots” are currently limited to offices or homes, coffee shops, airports and neighborhood area networks. It is expected that hotspots will become more prevalent as more systems are installed. Additionally, mobile communication devices are often also Bluetooth enabled with a Bluetooth transceiver.

Multi-mode phones can leverage the ubiquity of cellular networks (GSM and CDMA) with the high performance and low operational costs of local-area Wi-Fi networks. The dual-mode roaming capability allows wireless handsets to utilize cellular or Wi-Fi networks to place and receive calls, and to provide Internet access for email and Web surfing while the device is in an active mode.

The advantages of Wi-Fi networks include low connection fees, high indoor signal strength and higher data throughputs. The cellular networks have a disadvantage of high cost for connection time. In a dual-mode communication device, the mobile communication device may have two active phone numbers, for example, one of a GSM service provider, the other being a VoIP telephone number. A caller may send a communication to a dual-mode telephone using a GSM telephone number while the user is within a Wi-Fi range. The user may prefer that the communication take place using the VoIP telephone number. It would be beneficial if a user could redirect telephone calls from one network to another depending upon cost of communication and signal strength.

### BRIEF DESCRIPTIONS OF THE DRAWINGS

FIG. 1 illustrates a mobile communication device equipped with multiple transceivers for multi-mode operations according to an embodiment;

FIG. 2 depicts a mobile communication device such as shown in FIG. 1;

FIG. 3 is a flow chart illustrating an embodiment of a method as described herein; and

FIG. 4 illustrates an embodiment of a method including various factors that can be considered in a weighted calculation in the selection process.

### DETAILED DESCRIPTION

Described are methods, and mobile communication devices having multiple communication line capability, for communicating via at least a first service provider and a second service provider. In one embodiment, a method includes receiving a first communication via the first service provider, the first communication including caller identification information of the first communication. A determination of a value of a tariff or a signal strength of the first service provider and the second service provider is made. Potentially, the value of the tariff or signal strength of the second service provider is superior over that of the first service provider. From this determination the second service provider may be selected based on the value of the tariff or the signal strength of the first and second service provider. The first communication is terminated so that a second communication can be instigated based on the caller identification information via the second service provider. In this way, the mobile communication device may call back the caller via the second service provider so that either or both the cost of the call and the signal strength of the call may be better than it would have been via the first service provider.

In another embodiment, a second communication is instigated that includes prompting the caller, for example on the caller's display, to indicate whether the second communication should be initiated, the second communication being directed to a telephone number of the mobile communication device according to the second service provider.

In this way, the caller may establish communication via a service provider that does not provide the better service for the called party, but may be re-directed by the mobile communication device of the called party to establish communication via a second service provider that provides better service for the called party. Accordingly, it is not necessary for the caller to know the location of the called party such as when the called party is within Wi-Fi range. The change from the first service provider to the second service provider may be automatic or instigated by prompt.

The instant disclosure is provided to further explain in an enabling fashion the best modes of making and using various embodiments in accordance with the present invention. The disclosure is further offered to enhance an understanding and appreciation for the invention principles and advantages thereof, rather than to limit in any manner the invention. The invention is defined solely by the appended claims including any amendments of this application and all equivalents of those claims as issued.

It is further understood that the use of relational terms, if any, such as first and second, top and bottom, and the like are used solely to distinguish one from another entity or action without necessarily requiring or implying any actual such relationship or order between such entities or actions. Much of the inventive functionality and many of the inventive principles are best implemented with or in software programs or instructions and integrated circuits (ICs) such as application specific ICs. It is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. Therefore, in the interest of brevity and minimization of any risk of obscuring the principles and concepts according to the present invention, further discussion of such software and ICs, if any, will be limited to the essentials with respect to the principles and concepts within the preferred embodiments.

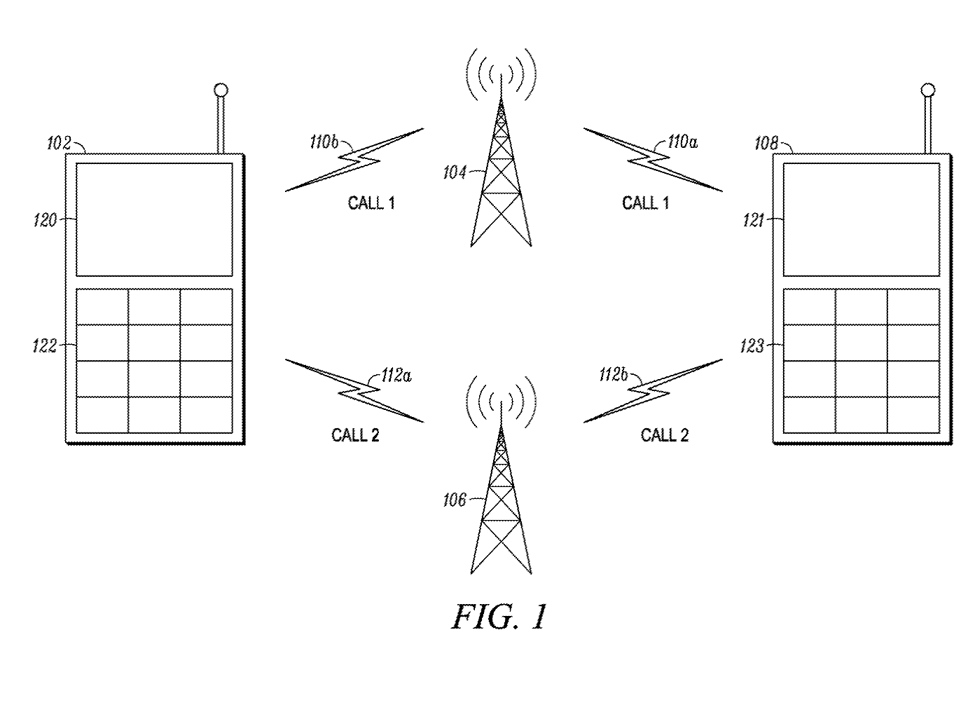

FIG. 1 illustrates a mobile communication device 102 equipped with multiple transceivers for multi-mode operations. Having at least two transceivers enables the mobile communication device to communicate via at least two service providers 104 and 106. In one embodiment, one transceiver may communicate according to CDMA or GSM protocols. Another transceiver may provide communication via VoIP protocol over a Wireless Fidelity (Wi-Fi) or wireless local area network (WLAN). It is understood that mobile communication device 102 may be multi-mode, communicating via at least two service providers.

The mobile communication device 102 may be implemented as a cellular telephone (also called a mobile phone). The mobile communication device 102 represents a wide variety of devices that have been developed for use within various networks. Such handheld communication devices include, for example, cellular telephones, messaging devices, personal digital assistants (PDAs), notebook or laptop computers incorporating communication modems, mobile data terminals, application specific gaming devices, video gaming devices incorporating wireless modems, and the like. Any of these portable devices may be referred to as a mobile station or user equipment. Herein, wireless communication technologies may include, for example, voice communication, the capability of transferring digital data, SMS messaging, Internet access, multi-media content access and/or voice over internet protocol (VoIP).

The networks 104 and 106 of course may be any type of wireless network including an ad hoc or wireless personal area network, a Wi-Fi or wireless local area network, and a cellular or wireless wide area network. Each may include a server. Likewise, a server may be of any suitable configuration. A server may be implemented as a single server or as a plurality of servers in communication in any arrangement. The operations of the server may be distributed among different servers or devices that may communicate in any manner. It is understood that the depiction in FIG. 1 is for illustrative purposes.

FIG. 1 further illustrates another mobile communication device 108 that is also capable of communication via the two service providers, and is the calling device. Both the called device 102 and the calling device 108 can include display devices 120 and 121 and keypads 122 and 123, respectively. While illustrated as a mobile communication device, it is understood that it may be any type of device, including a landline device. The calling device 108 may initiate a communication 110a with the called device 102 which receives communication 110b via the first service provider 104. After a determination of a value of a tariff and/or a signal strength of the first service provider and the second service provider is made by the mobile communication device 102, it may make a determination to communicate via the second service provider 106. In that event, the communications 110a and 110b can be terminated by the called device 102 and communications 112a and 112b via the second service provider 106 can commence to the calling device 108.

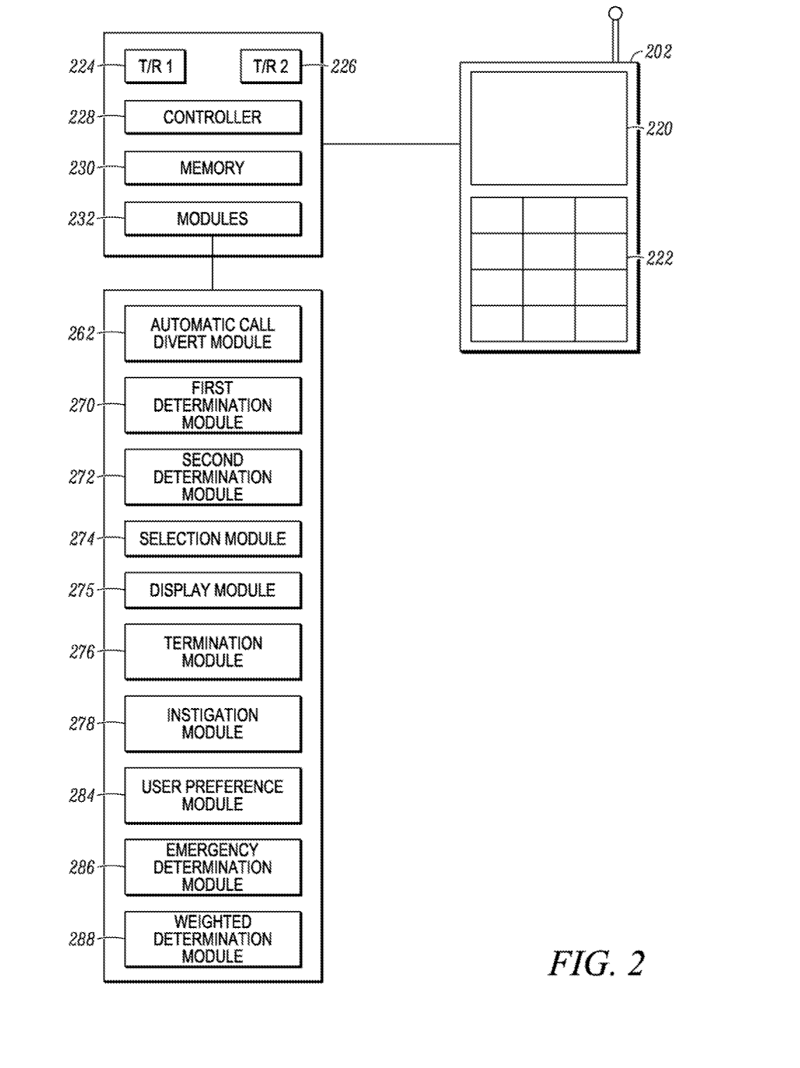

FIG. 2 depicts a mobile communication device 202 such as device 102 shown in FIG. 1. Mobile communication device 202 can include a display device 220, a keypad 222, a first transceiver 224, a second transceiver 226, a controller 228, memory 230 and modules 232. Of course, the device 202 can include two or more transceivers. The modules can include an automatic call divert module 262, a first determination module 270, a second determination module 272, a selection module 274, a display module 275, a termination module 276, an instigation module 278, a user preference module 284, an emergency call determination module 286, and a weighted determination module 288. The modules can carry out certain processes of the methods as described herein. The modules can be implemented in software, such as in the form of one or more sets of prestored instructions, and/or hardware, which can facilitate the operation of the mobile station or electronic device as discussed below. The modules may be installed at the factory or can be installed after distribution by, for example, a downloading operation. The operations in accordance with the modules will be discussed in more detail below.

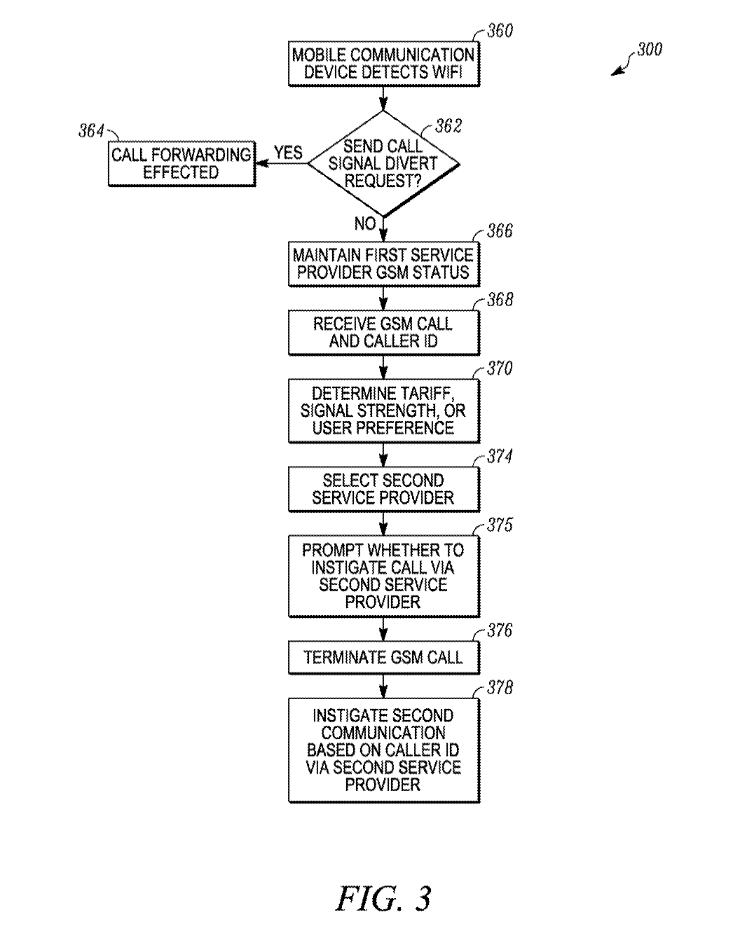

FIG. 3 is a flow chart illustrating an embodiment of a method 300. In one situation, a user may carry a multi-mode mobile communication device such a mobile communication device 202 (see FIG. 2) into a Wi-Fi zone that can be depicted as the second service provider 106 (see FIG. 1). The device may detect that it is within Wi-Fi range 360 and send a call divert request 362 to its GSM or its CDMA service provider 104. In response, call forwarding from the GSM or CDMA service provider to the Wi-Fi network may be effected 364. An automatic call divert module 262 may automatically divert a call to the second network being the Wi-Fi network when the device determines it is within range of the second network.

Alternatively, call forwarding may not be effected and communication via a GSM or CDMA service provider may be maintained 366. A user being the called party of device 202 may have disabled the automatic call divert function when entering a Wi-Fi zone, or there may be no call divert, or the automatic call divert function may have malfunctioned. Therefore, while in Wi-Fi range, a communication may be received via the first service provider, for example via a GSM or CDMA service provider 368, the communication including caller identification information. The display device 220 (see FIG. 2) may show the caller identification and that the communication is via the first service provide, such being a non-Wi-Fi service provider.

The method 300 of the mobile communication device 202 can include determining a value of a tariff or a signal strength of the first service provider and determining a value of a tariff or a signal strength of the second service provider 370. The device can then select the second service provider 374 based on the value of the tariff or the signal strength of the first and second service providers. A first determination module 270 (see FIG. 2) is coupled to the controller and can include instructions for determining a value of a tariff or a signal strength of the first service provider. A second determination module 272 coupled to the controller can include instructions for determining a value of a tariff or a signal strength of the second service provider. A selection module 274 coupled to the controller can include instructions for selecting the second service provider based on the value of the tariff or the signal strength of the first and second service providers.

In this embodiment, a prompt may be provided 375 to query the called party as to whether to terminate the first communication. A prompt on the display screen 220 (see FIG. 2) may query the called party as to whether to terminate the communication via the first service provider and whether to instigate a second communication based on the caller identification information via the second service provider. Alternatively, the prompt on the display screen 220 may query the called party whether to instigate a second communication that includes prompting the caller on the display screen 121 (see FIG. 1) to indicate whether the second communication should be initiated, the second communication being directed to a telephone number of the mobile communication device associated with the second service provider. A response to the prompt to the calling party may be entered via the keypad 123 of the calling party's device 108 (see FIG. 1). A display module 275 of the called party's device 202 may provide the prompt to initiate the communication 112a and 112b (see FIG. 1) to the calling party's device 108.

If the response to the prompt is positive, the first communication can be terminated 376 either prior to or after a second communication is instigated 378 based on the caller identification information via the second service provider 106 (see FIG. 1) automatically. Alternatively, a second communication can be instigated that includes prompting the called party 378 to indicate whether the second communication should be instigated, the second communication being directed to a telephone number of the mobile communication device associated with the second service provider. In either event, a termination module 276 is coupled to the controller and includes instructions for terminating the first communication when the selection process is made and it is determined to use the services of the second service provider. The termination module may affect termination prior to or after the instigation module 278 initiates a second communication. A device may carry on communication over more than one transceiver at a time. That is, a device with more than one transceiver may carry on two separate communications simultaneously. In one embodiment, communication may be over a GSM transceiver and a VoIP transceiver over Wi-Fi simultaneously. An instigation module 278 that is coupled to the controller can include instructions for instigating a second communication based on the caller identification information via the second service provider. If the termination module is configured to terminate the first call after the second call is instigated, the device may first determine if the second communication was successfully established before termination of the first communication. In any event, the mobile communication device 202 (see FIG. 2) of the called party is configured to make the determination as to whether to terminate the communication that is received via the first service provider and instigate and re-establish communication with the mobile communication device 108 (see FIG. 1) of the calling party via the second service provider.

It is understood that there can be other factors for making the determination to terminate the communication via the first service provider and to instigate communication via the second service provider. For example, both values for tariff and for signal strength may be considered. In doing so the determination may include weighting the values to make the selection. Additional factors such as user preferences and emergency calls may be independently or simultaneously considered in the selection process of the second service provider.

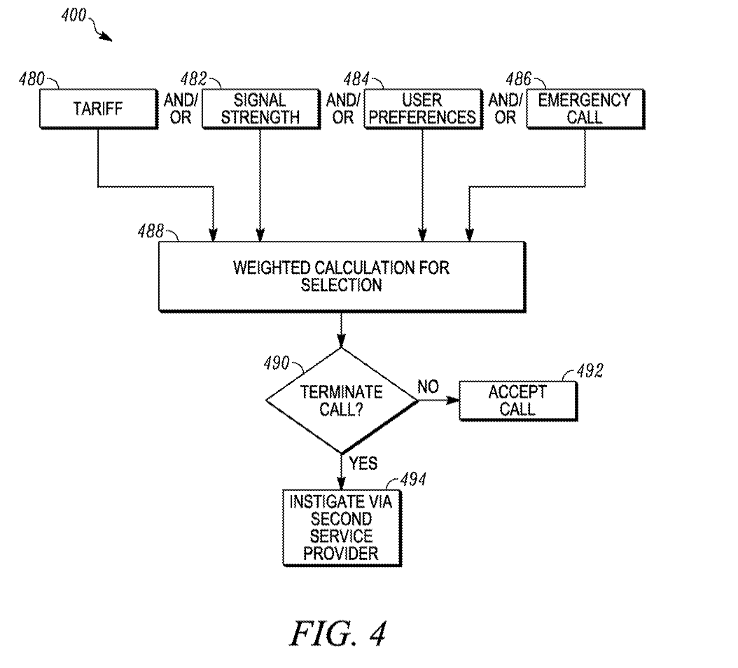

FIG. 4 illustrates a method 400 including various factors that can be considered in a weighted calculation in the selection process. As above, the method 400 of the mobile communication device 202 can include determining a value of a tariff 480 of the first and second service provider and/or a signal strength 482 of the first service provider and of the second service provider. Additionally, the method 400 can include determining a value for user preferences 484 relating to the first service provider and/or determining a value for user preferences relating to the second service provider. A user preference determination module 284 can be coupled to the controller and include instructions for determining user preferences relating to the first service provider and the second service provider. Whether the communication via the first service provider is an emergency call 486 can be factored in to the selection process as well. An emergency determination module 286 can be coupled to the controller and include instructions for determining whether the communication via the first service provider is an emergency call. The selection process 488 of the second service provider can based on a weighted values relating to the first and second service providers of all or some or one of the above listed factors. The weighted determination module 288 coupled to the controller can include instructions for weighting various factors during the selection process.

As above, upon a query or automatically the communication via the first service provider can be terminated 490 either prior to or after the second communication is instigated. If the communication is not terminated, the communication can be accepted 492. A situation where the communication may not be terminated may be for example, if there is a determination that the first communication via the first service provider that includes receiving the first communication from a caller is an emergency call, then the method 400 can include aborting the selecting, terminating and instigating steps. If the selection of the second service provider is made, the communication via the first service provider can be terminated and a communication as described above can be instigated via the second service provider 494.

The weighted determination module 288 can be coupled to the controller and can include instructions for weighting a value of a tariff and/or the signal strength of the second service against user preferences and emergency call factors to make a selection according to the selection module. It is understood that other factors, hierarchical analysis and algorithms may be included in the determination as to whether to select the second service provider 106 (see FIG. 1), in this example, the Wi-Fi service provider.

If the called party terminates the first communication 110a and 110b via the first service provider 104 and instigates the second communication 112a and 112b via the second service provider 106, the instigating of a second communication can include providing a video and/or audio signal including a telephone number of the mobile communication device according to the second provider.

In the previous example, the dual mode mobile communication device provided communication via CDMA or GSM and VoIP protocols. Another situation may occur for example where the mobile communication device is a multi-mode device including transceivers for both GSM and CDMA protocols. It is understood that a mobile communication device may include any number of transceivers that can communicate in accordance with any protocols. In this case, it would be beneficial if a user could redirect telephone calls from one network to another depending upon cost of communication and/or signal strength. In this way, the caller may initially establish communication via a service provider 104 that does not provide the better service for the called party, but may be re-directed by the mobile communication device 102 of the called party to establish communication via a different service provider 106 that provides better service for the called party.

This disclosure is intended to explain how to fashion and use various embodiments in accordance with the technology rather than to limit the true, intended, and fair scope and spirit thereof. The foregoing description is not intended to be exhaustive or to be limited to the precise forms disclosed. Modifications or variations are possible in light of the above teachings. The embodiment(s) was chosen and described to provide the best illustration of the principle of the described technology and its practical application, and to enable one of ordinary skill in the art to utilize the technology in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally and equitable entitled.

1. A method in a mobile communication device having multiple communication line capability including a first service provider and a second service provider, the method comprising:
receiving a first communication via the first service provider, the first communication including caller identification information of the first communication;
determining a value of a tariff or a signal strength of the first service provider;
determining a value of a tariff or a signal strength of the second service provider;
selecting the second service provider based on the value of the tariff or the signal strength of the first and second service providers; and
instigating a second communication based on the caller identification information via the second service provider.

2. The method of claim 1, further comprising:
terminating the first communication prior to instigating the second communication or after instigating the second communication.

3. The method of claim 1, wherein instigating a second communication includes providing an audio signal including a telephone number of the mobile communication device according to the second provider.

4. The method of claim 1, wherein instigating a second communication includes providing a video signal including a telephone number of the mobile communication device according to the second provider.

5. The method of claim 1, wherein:
receiving a first communication via the first service provider including receiving the first communication from a caller; and
instigating a second communication includes prompting the caller to indicate whether the second communication should be initiated, the second communication being directed to a telephone number of the mobile communication device according to the second service provider.

6. The method of claim 1, further comprising:
determining a value of a tariff and a signal strength of the first service provider;
determining a value of a tariff and a signal strength of the second service provider; and
selecting the second service provider based on a weighted value of the tariff or the signal strength of the first and second service providers.

7. The method of claim 1, further comprising:
determining a value for user preferences relating to the first service provider;
determining a value for user preferences relating to the second service provider; and
selecting the second service provider based on a weighted value for user preferences for the first and second service providers and tariff or signal strength of the first and second service providers.

8. The method of claim 7, further comprising:
determining a value for user preferences relating to the first service provider;
determining a value for user preferences relating to the second service provider; and
selecting the second service provider based on a weighted value for user preferences for the first and second service providers and tariff and signal strength of the first and second service providers.

9. The method of claim 1, further comprising:
determining whether the first communication via the first service provider that includes receiving the first communication from a caller is an emergency call;
aborting the selecting, terminating and instigating steps.

10. A method in a mobile communication device having multiple communication line capability including a first service provider and a second service provider, the method comprising:
receiving a first communication via the first service provider that includes receiving the first communication from a caller;
determining a value of a tariff or a signal strength of the first service provider;
determining a value of a tariff or a signal strength of the second service provider;
selecting the second service provider based on the value of the tariff or the signal strength of the first and second service providers; and
instigating a second communication that includes prompting the caller to indicate whether the second communication should be initiated, the second communication being directed to a telephone number of the mobile communication device according to the second service provider.

11. The method of claim 10, further comprising:
terminating the first communication prior to instigating the second communication or after instigating the second communication.

12. The method of claim 10, wherein instigating a second communication includes providing an audio signal including a telephone number of the mobile communication device according to the second provider.

13. The method of claim 12, wherein instigating a second communication includes providing a video signal including a telephone number of the mobile communication device according to the second provider.

15. The method of claim 10, further comprising:
determining a value of a tariff and a signal strength of the first service provider;
determining a value of a tariff and a signal strength of the second service provider; and
selecting the second service provider based on a weighted value of the tariff or the signal strength of the first and second service providers.

16. The method of claim 10, further comprising:
determining whether the first communication via the first service provider that includes receiving the first communication from a caller is an emergency call;
aborting the selecting, terminating and instigating steps.

17. A mobile communication device having multiple communication line capability,
a first transceiver for receiving a first communication via a first service provider that include receiving a first communication from a caller;
a second transceiver for transmitting a second communication via a second service provider;
a controller coupled to the first transceiver and the second transceiver;
a first determination module coupled to the controller and including instructions for determining a value of a tariff or a signal strength of the first service provider;
a second determination module coupled to the controller and including instruction for determining a value of a tariff or a signal strength of the second service provider;
a selection module coupled to the controller and including instruction for selecting the second service provider based on the value of the tariff or the signal strength of the first and second service providers; and
an instigation module coupled to the controller and including instructions for instigating a second communication based on the caller identification information via the second service provider.

18. The device of claim 17, further comprising:
a termination module coupled to the controller and including instructions for terminating the first communication.

19. The device of claim 17, further comprising:
an emergency determination module to determine whether the communication from the caller is an emergency.

20. The device of claim 17, further comprising:
an automatic call divert module for automatically diverting a call to the second network that is initiated when the device determines it is within range of the second network.
